(19) United States
(12) Patent Application Publication
(10) Pub. No.: US 2009/0188116 A1
(43) Pub. Date: Jul. 30, 2009

(54) FLOOR SCRAPER

(76) Inventors: Gary E. van Deursen, Essex, CT (US); David W. Kaiser, North Haven, CT (US); Luke Johnson, Seymour, CT (US)

Correspondence Address: MCDERMOTT WILL & EMERY LLP, 600 13TH STREET, N.W., WASHINGTON, DC, 20005-3096, US

(21) Appl. No.: 12/362,770

(22) Filed: Jan. 30, 2009

Related U.S. Application Data
(60) Provisional application No. 61/006,753, filed on Jan. 30, 2008.

(51) Int. Cl. B26B 3/00

(52) U.S. Cl. 30/170; 30/169

(57) ABSTRACT

An ergonomic scraper, such as a floor scraper using a standard replaceable blade, is provided. Embodiments include a scraper having an elongated handle, a scraper head for fixedly holding a blade mounted to a first end of the handle, an upper hand grip at a second end of the handle, and a lower hand grip between the first and second ends of the handle. The handle has an S-shape to reduce the angle between the blade and a workpiece. A pair of wheels is mounted near the scraper head for easily adjusting the blade attack angle. The scraper head is adjustable for changing the scraping angle of the blade to suit the user and/or the job.

### RELATED APPLICATION

The present invention claims priority of provisional patent application No. 61/006,753 filed Jan. 30, 2008, the contents of which are incorporated herein in their entirety.

### TECHNICAL FIELD

The present disclosure relates to a scraper. The present disclosure has particular applicability to floor scrapers with replaceable blades.

### BACKGROUND

Floor scrapers, also called floor strippers, are used to remove tile, glue, etc. from floors. Present floor scrapers consist of a straight steel tube handle with rubber hand grips around it. At the working end, the tube is connected to a metal housing, known as a scraper head, holding a scraper blade. A typical conventional design uses a standard replaceable blade, such as an 8″ scraper blade, held in place to a head by screws and a flat plate that mates with the head.

The attack angle of the blade is dependent on the height of the user at the end of the tube and/or the amount that the user is bent over. Having the wrong attack angle can damage the floor and hurt the user. However, conventional designs do not allow the flexibility to afford all users an ideal attack angle.

Also, the position of the head is fixed at an angle to the handle, to accommodate right-handed people. Disadvantageously, the fixed scraping angle is often not quite right for the user or for a particular work situation, which may require a greater or lesser angle for scraping effectiveness and/or efficiency.

### SUMMARY OF THE DISCLOSURE

An advantage of the present disclosure is an ergonomic floor scraper for easily and comfortably adjusting the attack angle of the blade, thereby reducing the amount of bending required of the user.

According to the present disclosure, the foregoing and other advantages are achieved in part by a scraper comprising an elongated handle; a scraper head for fixedly holding a blade, the scraper head being mounted to a first end of the handle; an upper hand grip at a second end of the handle; and a lower hand grip between the first and second ends of the handle. The handle has an S-shape to reduce the angle between the blade and a workpiece when the upper and lower hand grips of the handle are held by a user and the blade contacts the workpiece.

Additional advantages and other features of the present disclosure will be set forth in part in the description which follows and in part will become apparent to those having ordinary skill in the art upon examination of the following or may be learned from the practice of the disclosure. The advantages of the disclosure may be realized and obtained as particularly pointed out in the appended claims.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIG. 1 is a perspective view of a scraper according to an embodiment of the present disclosure;

FIG. 2 is a front view of the scraper according to FIG. 1;

FIG. 3 is a rear view of the scraper according to FIG. 1;

FIG. 4 is a side view of the scraper according to FIG. 1;

FIG. 5 is a top view of the scraper according to FIG. 1;

FIG. 6 is a bottom view of the scraper according to FIG. 1;

FIG. 7 is a partial front perspective view of the scraper according to FIG. 1;

FIG. 8 is a partial front perspective view of the scraper according to FIG. 1;

FIG. 9 is a partial side view of the scraper according to FIG. 1;

FIGS. 10a-b are views of an alternative embodiment of the scraper according to the present disclosure; and

FIGS. 11a-b are views of another alternative embodiment of the scraper according to the present disclosure.

### DETAILED DESCRIPTION

A floor scraper according to the present disclosure addresses the disadvantages of conventional floor scrapers, which are not ergonomically desirable, and have a head at a fixed angle to the handle. The present disclosure provides a scraper with and S-shaped handle and a set of wheels for easily and comfortably adjusting the blade attack angle, and an adjustable scraper head whose blade angle with respect to the handle can be changed to suit the user and/or the job. The scraper of the present disclosure also has textured grips for both the user's hands, for better control.

One embodiment of the present disclosure shows a floor scraper 10 having an “S” shaped handle 11 to reduce the scraper attack angle and decrease the amount of bending required. Handle 11 includes an upper hand grip 12, an upper handle element 14, a lower hand grip 17, a lower handle element 16, and a scraper head 18. The handle 11 is made of the two identical curved handle elements 14, 16 and is connected in the center. This allows for a smaller package in shipping and in storage.

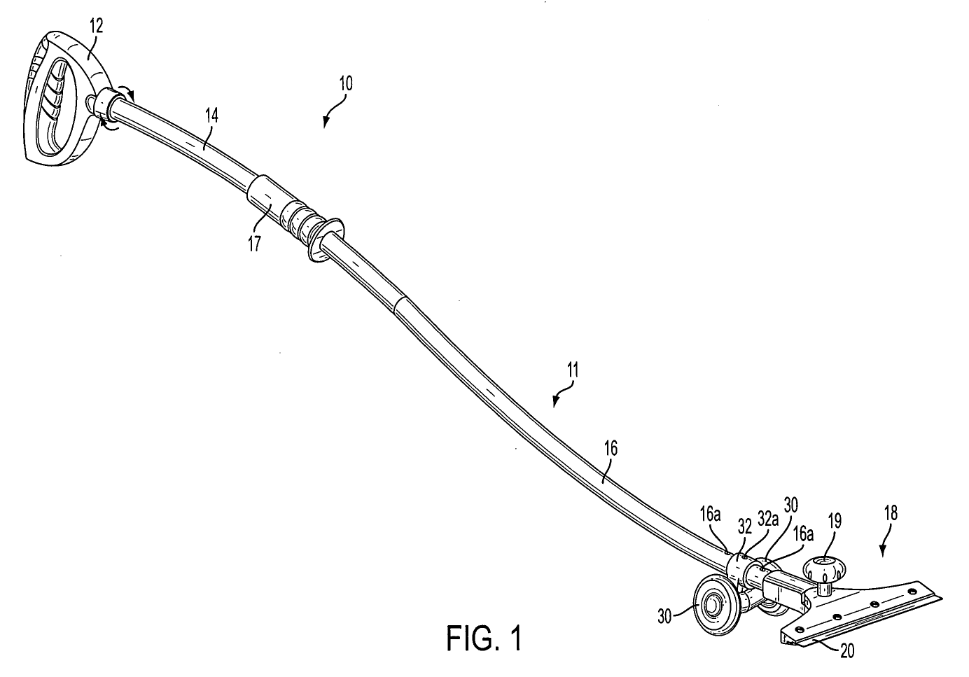

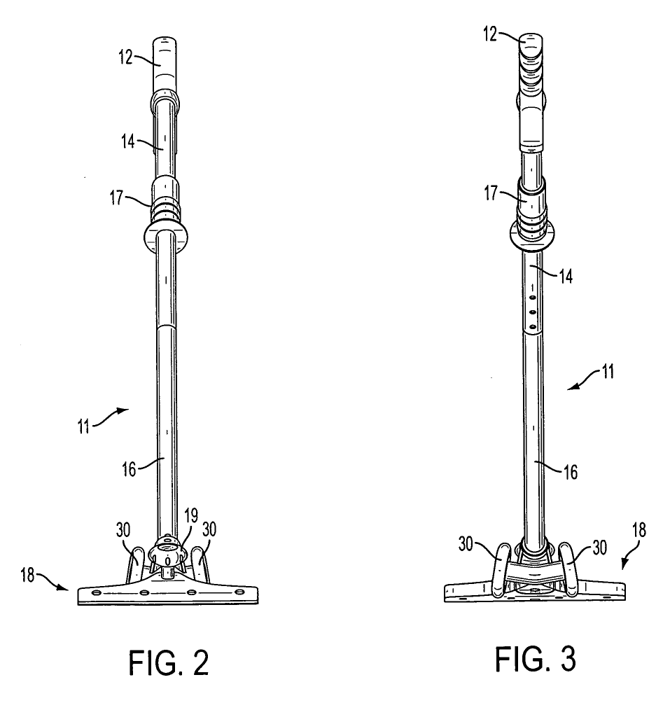

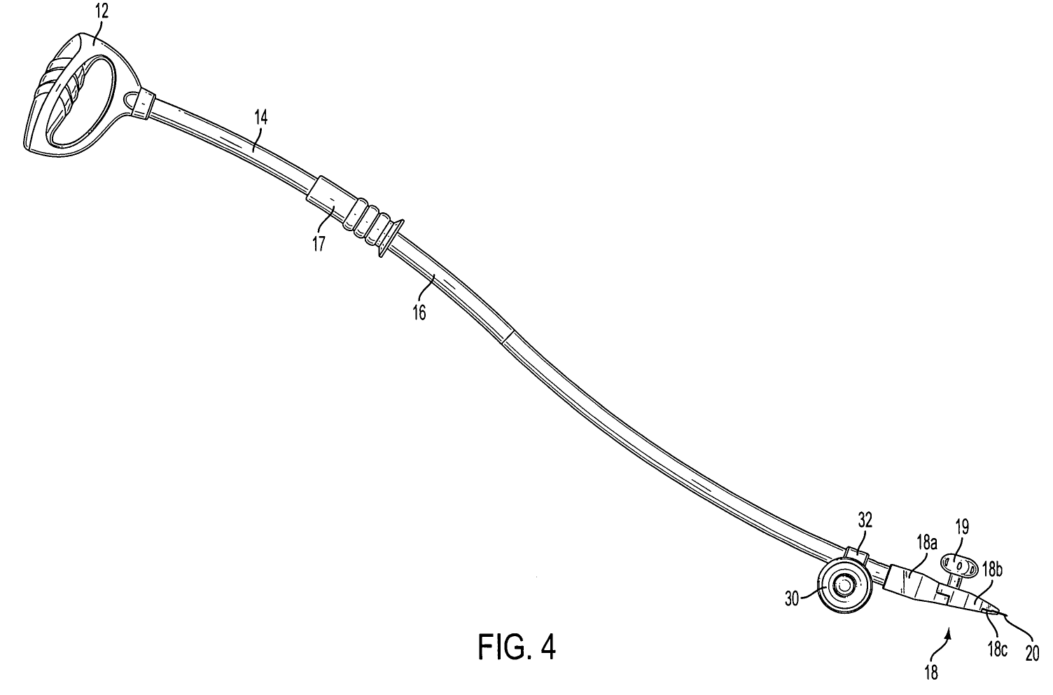

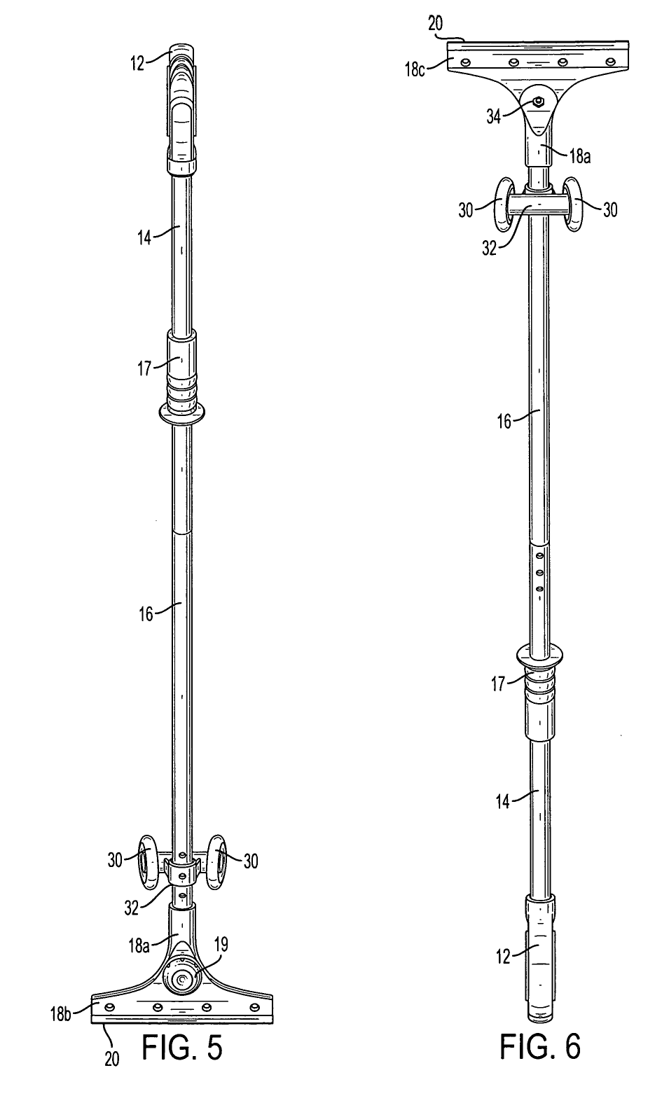

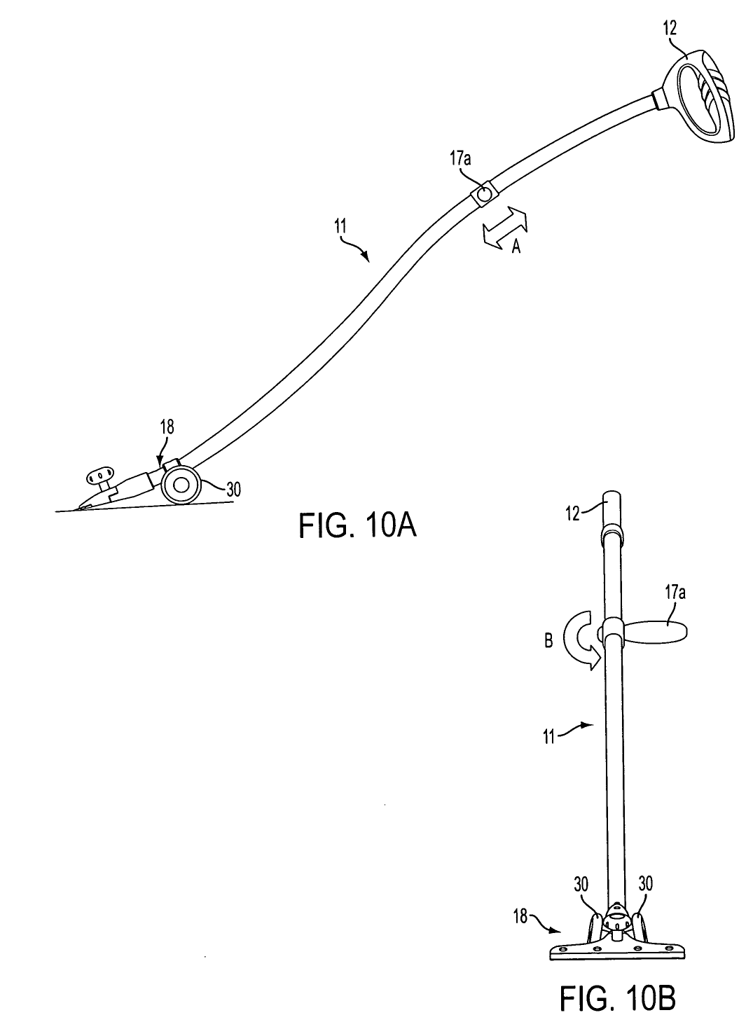

The upper hand grip 12 is a “D-shaped” configuration, and is padded and/or textured, to provide better ergonomics, grip force and control. The angle of grip 12 is adjustable as shown by the arrows in FIG. 1 (i.e., rotatable about the end of handle 11) for user comfort. The lower hand grip 17 is also padded and/or textured, and is slidable forward and back along the handle 11 in a conventional manner for improved ergonomics. In certain embodiments of the present disclosure shown in FIGS. 10a and b, a lower hand grip 17a is provided that extends substantially perpendicularly from handle 11 and is slidable forward and back along handle 11 in the direction of arrows A in FIG. 10a, and is further rotatable about the handle (i.e., in the direction of arrows B in FIG. 10b), for improved ergonomics.

At the working end of handle 11, near the scraper head 18, there are a set of angled wheels 30 connected to the handle by a collar 32. The wheels 30 help stabilize the scraper 10 and help control the attack angle. The wheels 30 are adjustable; by moving collar 32 and wheels 30 up or down the handle 11, the desired attack angle changes. In certain embodiments, the wheels 30 are adjusted by aligning one of three holes 16a in lower handle element 16 with a detent 32a in collar 32. However, wheels 30 can be made to adjust in any conventional manner. The wheels 30 lean in toward the handle 11, creating a wider stance for greater control. The wheels 30 are also removable if the user prefers, by sliding.

The scraper head 18 includes a knob 19 and a scraper blade 20. The angle of the blade 20 is adjustable in two directions. First, the angle of the blade 20 with respect to the floor may be adjusted by moving the wheels 30 into one of the various positions. Second, the angle of the scraper head 18 can be adjusted with respect to the longitudinal axis of the handle 11 (e.g., up to 15 degrees to the left or right) by loosening the knob 19 and moving the scraper head 18 to a new position.

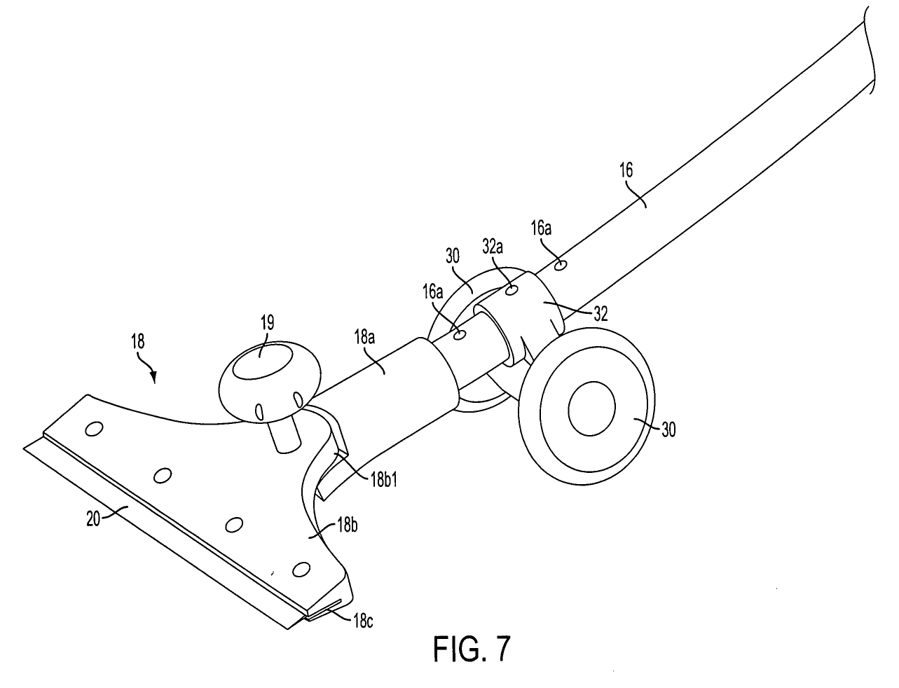

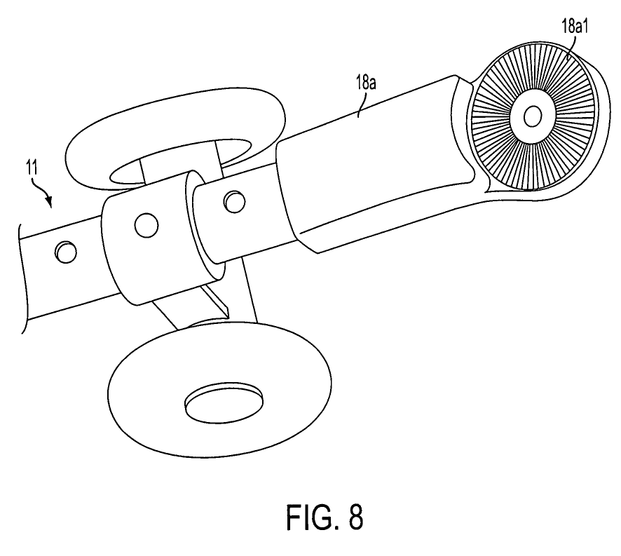

As shown in more detail in FIGS. 7-9, the head assembly 18 has a metal attachment member 18a which is securely fitted into the front end of handle 11, an upper head half 18b, and a lower head half 18c. Attachment member 18a includes a splined circular detent ring 18a1 which mates with a corresponding splined circular detent ring 18b1 of upper head half 18b. Knob 19 has a threaded shaft 19a which passes through aligned holes in upper head half 18b and attachment member 18a, and threads into a fastener, such as captivated nut 34, at the bottom of attachment member 18a. Thus, scraper head 18 is pivotably mounted to handle 11 via knob 19. The knob 19 acts as a lock to tighten and securely fix the upper head half 18b to the attachment member 18a, after their corresponding detent rings are engaged as desired by the user for selecting the blade attack angle (i.e., the angle of blade 20 relative to handle 11).

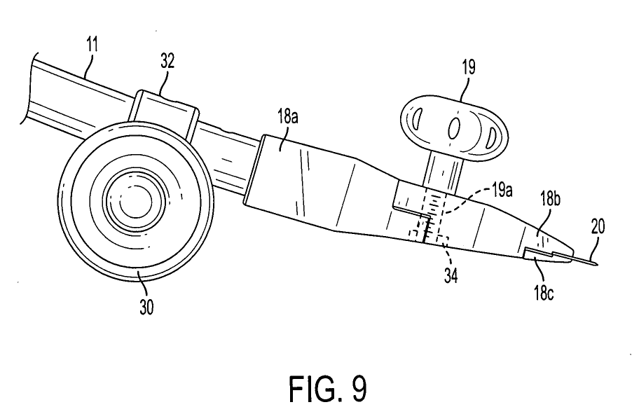

As shown in FIGS. 7 and 9, the blade 20 is captured in a conventional manner between upper head half 18b and lower head half 18c, such as via screws that pass through holes in upper head half 18b and corresponding through-holes in blade 20, and thread into holes in lower head half 18c. Blade 20 is a standard replaceable scraper blade, such as an 8″ scraper blade.

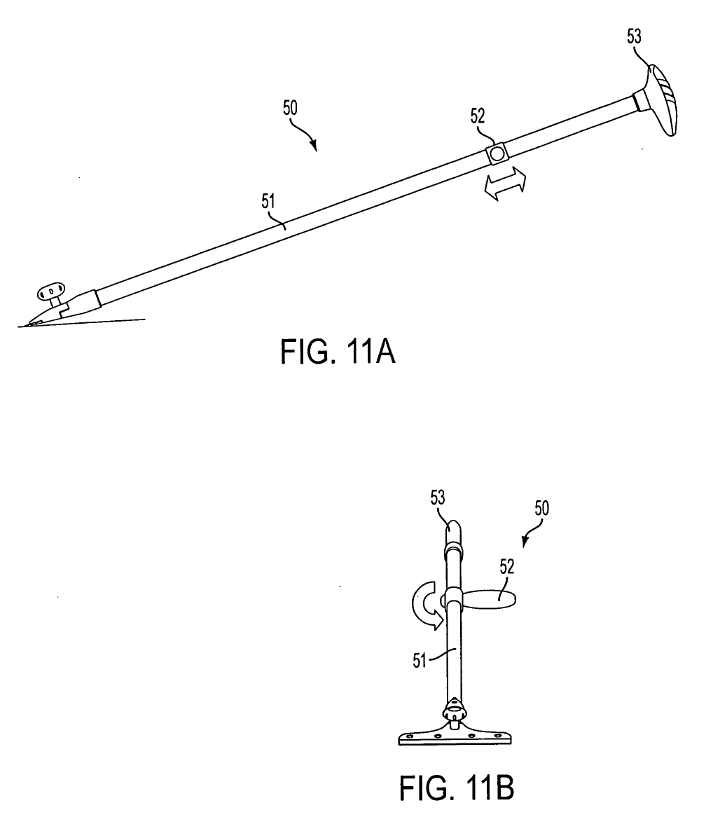

In another embodiment of the present disclosure, some of the features of scraper 10 can be used with a more conventional scraper 50, shown in FIGS. 11a-b. Scraper 50 includes a straight handle 51, instead of the S-shape of scraper 10. Scraper 50 also includes the same type of lower hand grip 52 and adjustable scraping angle as scraper 10, but has a different upper hand grip 53 and does not include wheels attached to handle 51.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can be practiced without resorting to the details specifically set forth. In other instances, well known processing structures have not been described in detail, in order not to unnecessarily obscure the present disclosure.

Only a few examples of the present disclosure are shown and described herein. It is to be understood that the disclosure is capable of use in various other combinations and environments and is capable of changes or modifications within the scope of the inventive concepts as expressed herein.

What is claimed is:

1. A scraper comprising:
an elongated handle;
a scraper head for fixedly holding a blade, the scraper head being mounted to a first end of the handle;
an upper hand grip at a second end of the handle; and
a lower hand grip between the first and second ends of the handle,
wherein the handle has an S-shape to reduce the angle between the blade and a workpiece when the upper and lower hand grips of the handle are held by a user and the blade contacts the workpiece.

2. The scraper of claim 1, comprising a pair of wheels rotatably mounted proximal to the scraper head such that the wheels contact the workpiece when the blade contacts the workpiece.

3. The scraper of claim 2, further comprising a collar for rotatably mounting the wheels, wherein the collar is adjustably mounted to the handle proximal to the scraper head.

4. The scraper of claim 3, wherein the collar is slidable up and down the handle.

5. The scraper of claim 2, wherein the wheels each lean in toward the handle.

6. The scraper of claim 1, wherein the upper hand grip is D-shaped.

7. The scraper of claim 6, wherein the upper hand grip is rotatable about the handle.

8. The scraper of claim 1, wherein the lower hand grip is slidable forward and back along the handle.

9. The scraper of claim 8, wherein the lower hand grip extends substantially perpendicularly from the handle.

10. The scraper of claim 9, wherein the lower hand grip is rotatable about the handle.

11. The scraper of claim 1, wherein the scraper head is pivotably mounted to the first end of the handle for positioning the scraper head at a selected angle to the handle; the scraper further comprising a lock engageable with the handle and the scraper head for fixing the scraper head at the selected angle.

12. The scraper of claim 11, wherein the lock comprises a shaft which engages respective through-holes in the handle and the scraper head to pivotably mount the scraper head to the handle, and
wherein the shaft further engages a fastener for fixing the scraper head at the selected angle.

13. The scraper of claim 12, wherein the lock further comprises a knob at one end of the shaft for engaging the shaft and the fastener, and for secure gripping of the lock by the user.

14. The scraper of claim 13, wherein the shaft is threaded, and the fastener has threads for engaging the threads of the shaft, and the knob is for tightening the shaft to the fastener.

15. The scraper of claim 12, wherein the handle has a first splined detent ring, and the scraper head has a second splined detent ring for engaging the first splined detent ring, for positioning the scraper head at the selected angle when the shaft engages the through-holes in the handle and the scraper head.

16. The scraper of claim 1, wherein the blade is removable.

17. A scraper comprising:
an elongated handle;
a scraper head for fixedly holding a blade, the scraper head being pivotably mounted to a first end of the handle for positioning the scraper head at a selected angle to the handle;
a lock engageable with the handle and the scraper head for fixing the scraper head at the selected angle;
an upper hand grip at a second end of the handle; and
a lower hand grip between the first and second ends of the handle.

18. The scraper of claim 17, wherein the upper hand grip is rotatable about the handle.

19. The scraper of claim 17, wherein the lower hand grip is slidable forward and back along the handle.

20. The scraper of claim 19, wherein the lower hand grip extends substantially perpendicularly from the handle.

21. The scraper of claim 20, wherein the lower hand grip is rotatable about the handle.
